(19) United States
(12) Patent Application Publication
(10) Pub. No.: US 2005/0045786 A1
(43) Pub. Date: Mar. 3, 2005

(54) Framework for supporting plants

(76) Inventors: Robert Roy Tupper, The Dalles, OR (US); Bob Tait, Clackamus, OR (US)

Correspondence Address: GLENN C. BROWN, PC, 777 NW WALL STREET, SUITE 308, BEND, OR, 97701, US

(21) Appl. No.: 10/927,352

(22) Filed: Aug. 25, 2004

Related U.S. Application Data
(60) Provisional application No. 60/497,942, filed on Aug. 25, 2003.

(51) Int. Cl. F16B 1/00

(52) U.S. Cl. 248/229.2; 248/230.1

(57) ABSTRACT

An apparatus for assembling support systems for plants and the like. The apparatus includes a first elongate member having an outer surface, a first collar adapted for interlockingly engaging the first elongate member and having interlocking first and second halves. Each of the first and second collar halves have first and second flanges. The first flange of each collar half is interlockingly engageable with the second flange of the other collar half to mount the first collar onto the first elongate member. The first collar first collar half has a connector engageable with a first collar half of a second collar. The connector has a first position for positioning the second collar at a predetermined angle to the first collar.

### CROSS-REFERENCE TO RELATED APPLICATION

This application is a continuation-in-part of U.S. provisional patent application Ser. No. 60/497,942, filed on Aug. 25, 2003. The priority of the prior application is expressly claimed and its disclosure is hereby incorporated by reference in its entirety.

### BACKGROUND OF THE INVENTION

Many plants require a support to reach their fullest productivity. Bush type plants such as tomatoes and beans are often staked or grown in a mesh cage. Berries, grapes, and some flowers require a support for their runners and vines to permit full growth and good exposure of the plant to sunlight.

Many types of support have been used including stakes, mesh cages, and strings stretched between stakes. While these methods of supporting the plants work more or less effectively, they are often pieced together and do not provide a consistently strong and visually appealing framework for supporting the plants.

This invention provides a strong and attractive framework system for supporting plants of nearly every type. The framework system of the present invention is adaptable to provide vertical and/or lateral support for most any plant. The framework system can be added on to as the plants grow. The system can provide linear support for use with crops like berries and grapes, and can also form enclosures for use with crops like tomatoes. In one embodiment nutrient solutions can be dispensed through the framework to the plants.

These and other features of the invention will be described in greater detail with reference to the drawings.

### BRIEF DESCRIPTION OF THE DRAWINGS

FIG. 1 is a perspective view of an assembly of the basic components of a framework system according to a preferred embodiment of the invention.

FIG. 2 is a second perspective view of an assembly of the basic components shown in FIG. 1.

FIG. 3 is a perspective view of the collar component of the system.

FIG. 4 is an enlarged perspective view of a partial assembly of a system according to the invention, highlighting the cross component that joins collars together at right angles.

FIG. 5 is a side elevational view of a collar having two side mounts attached thereto.

FIG. 6 is a cross-sectional view of the invention along line A-A.

FIG. 7 is a cross-sectional view of the invention along line B-B.

FIG. 8 is a perspective view of a partial assembly according to another preferred embodiment of the invention

FIG. 9 is a top plan view of a collar according the embodiment shown in FIG. 8.

FIG. 10 is a side elevational view of a collar according to the invention shown in FIG. 8.

FIG. 11 is a perspective view of two collars connected at an angle of 90 degrees.

FIG. 12 is a cross-sectional view of two collars connected at an angle of 90 degrees.

FIG. 13 perspective view of a collar according to the second preferred embodiment of the invention.

FIG. 14 is a partial enlarged view of the collar illustrated in FIG. 12.

### DETAILED DESCRIPTION OF THE PREFERRED EMBODIMENT

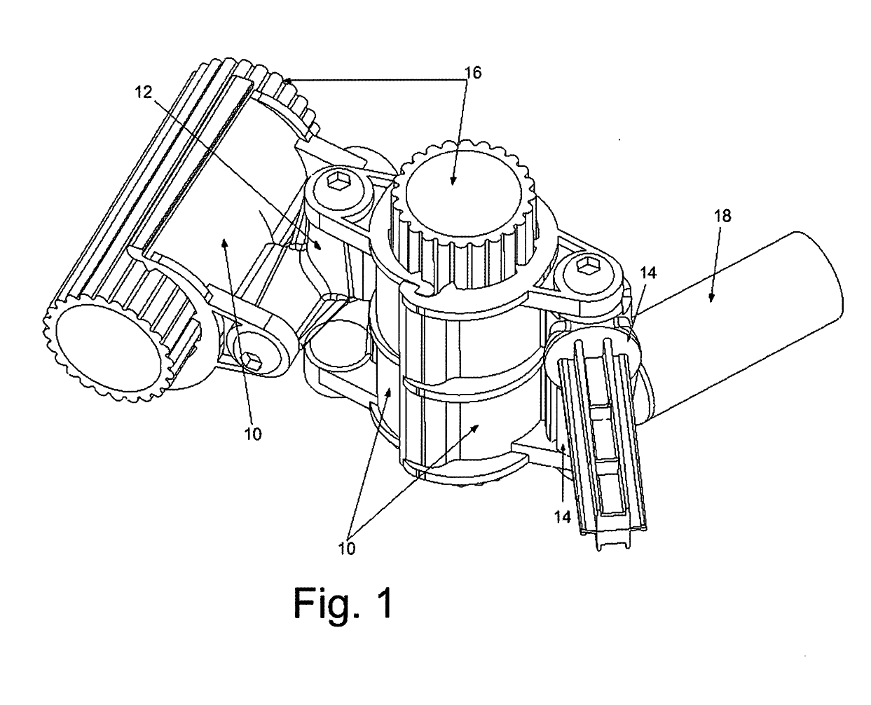

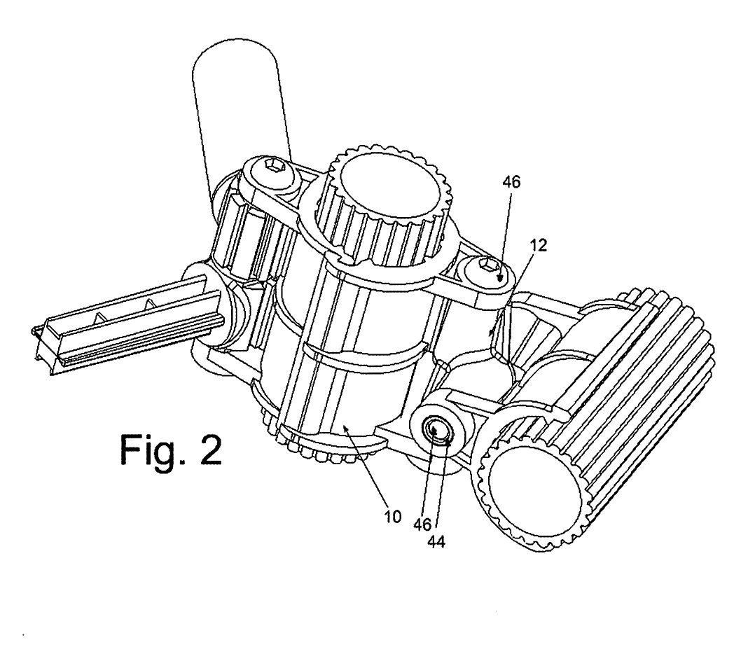

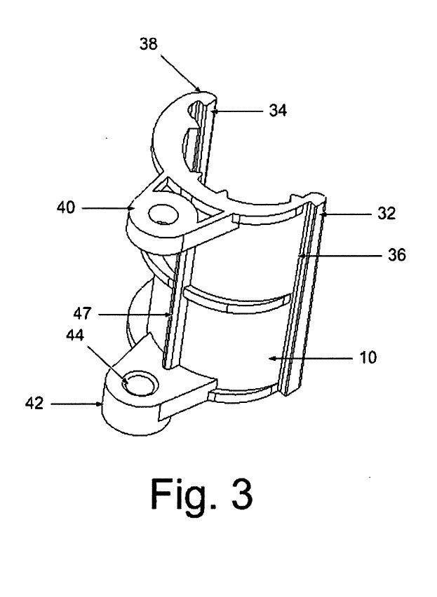

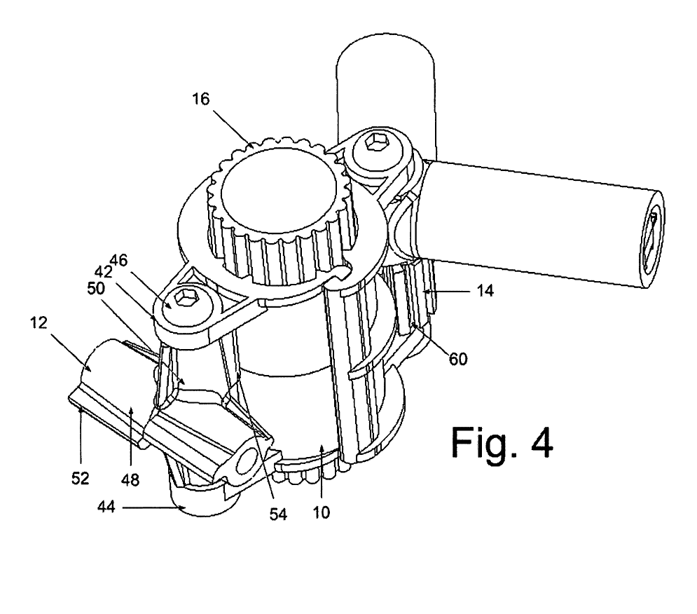

Referring to FIGS. 1-4, a preferred embodiment of the invention includes components of the following type: a collar 10, a cross 12, a side mount 14, a main spar 16, and a side tube 18. Collar 10 is shown in greater detail in FIG. 3, and includes an inner surface 30 having a plurality of protruding tabs 32 that are shaped and sized to interlock with the external fluting on a main spar 16 (FIG. 1). Each collar 10 will interlock on a spar 16 without a companion collar 10 as shown in FIG. 2. Each collar 10 includes male and female flanges 32 and 34 on opposed distal edges 36 and 38 respectively. As best seen in FIG. 4, the respective flanges 32 and 34 interlock with the corresponding flange on an opposite collar 10 to fully encircle a main spar 16 where additional strength is desired.

Main spar 16 as shown is an extruded pipe having longitudinal flutes along its length, and a main central passage defined by an inner wall. Webbing between the inner and outer walls provides additional strength to the main spar. The flutes are sized and shaped to receive protruding tabs 32 as described above.

Referring again to FIG. 3, collar 10 includes a pair of spaced apart tabs 40 and 42.

Tab 42 includes a threaded insert 44 (FIG. 2) that is provided to receive a threaded fastener 46. Threaded fasteners 46 are used to mount cross 12 to each of two collars 10 (FIG. 2), or to mount one or more side mounts 14 to a collar 10 (FIG. 4). Collar 10 includes a dorsal flange 47 that is engaged by cross 12 or side mount 14 as described below.

Cross 12 is provided to allow the perpendicular interconnection of two main spars 16. Cross 12 includes a pair of perpendicular hollow portions 48 and 50. Hollow portions 48 and 50 are sized to receive threaded fasteners 46 as described above. Cross 12 also includes a pair of flanges 52 and 54 along the outer surfaces of hollow portions 48 and 50 that are each shaped and sized to engage dorsal flange 47 of collar 10. Flanges 52 and 54 prevent rotation of cross 12 relative to collar 10, and fix main spars 16 into position relative to one another.

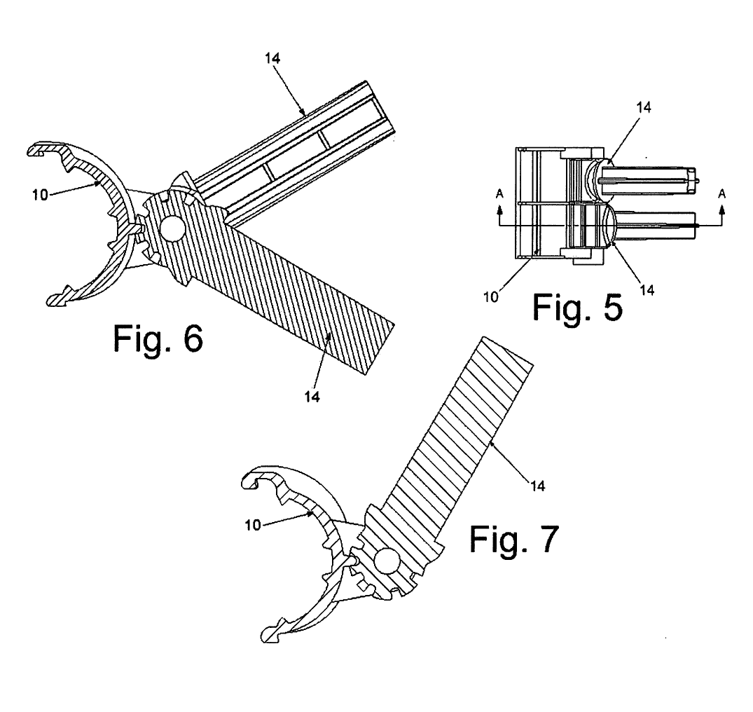

Referring also to FIGS. 5-7, the remaining component of the framework system according to the invention is side mount 14, which is best shown in FIGS. 1 and 4. Side mount 14 includes a generally cylindrical hollow body 56 and a protruding member 58 that is sized to be closely received in a hollow side tube 18. In the embodiment shown side mount 14 is sized so that two side mounts 14 can be mounted between flanges 42 and 44. In another preferred embodiment side mount 14 is sized so that a single side mount 14 fits between flanges 42 and 44.

In the embodiment shown, member 58 is sized to fit snugly into ½″ schedule 40 plastic pipe, although the invention is not limited to any particular side tube size. The outer surface of side mount 14 includes several longitudinal grooves 60 that are sized to receive dorsal flange 47 of collar 10. The grooves 60 are positioned around side mount 14 to provide multiple mounting positions for positioning side tubes 18 at convenient angles relative to the main spar 16. In the preferred embodiment each side mount includes grooves that orient member 58 at 15, 30 and 60 degrees relative to a line connecting flanges 42 and 44. By so doing a pair of side mounts can then be mounted at any combination of 0, 30, 45, 60, 90, 120, 150, and 180 degrees, providing maximum flexibility for constructing frame assemblies that meet the user's needs. One of a pair of the side mounts can be mounted upside down to provide complementary angles to those listed above.

Other preferred embodiments are shown in FIGS. 5-7 and differ from that described above in that the collars interlock by use of a pin as best shown in FIG. 5 rather than interlocking flanges. The embodiment of FIGS. 5-7 a Iso differ in that the side mount has a notched flange to orient the side mount relative to the main spar rather than a full length groove that engages the dorsal flange of the collar.

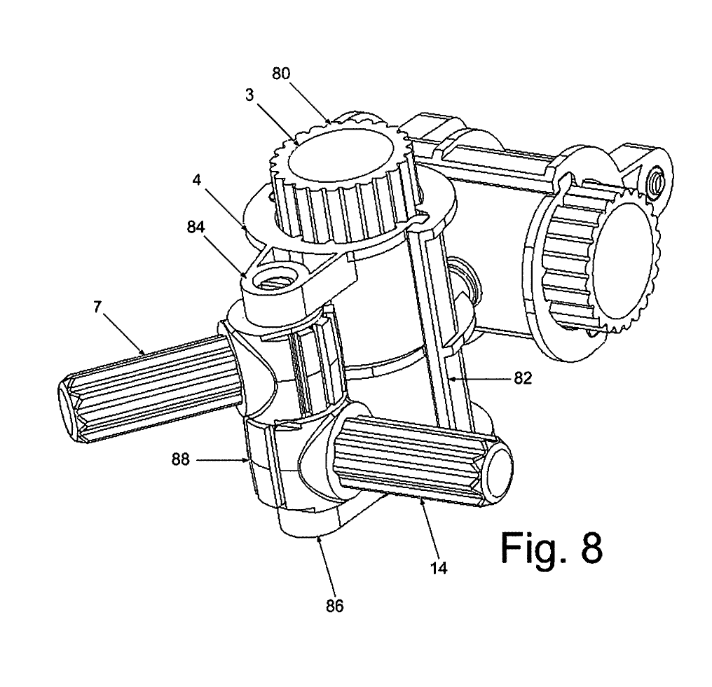

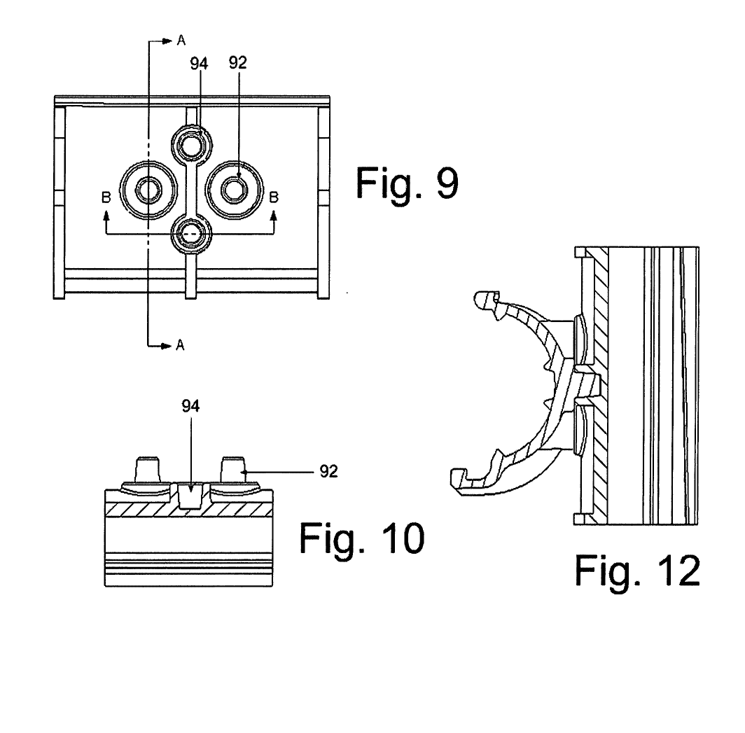

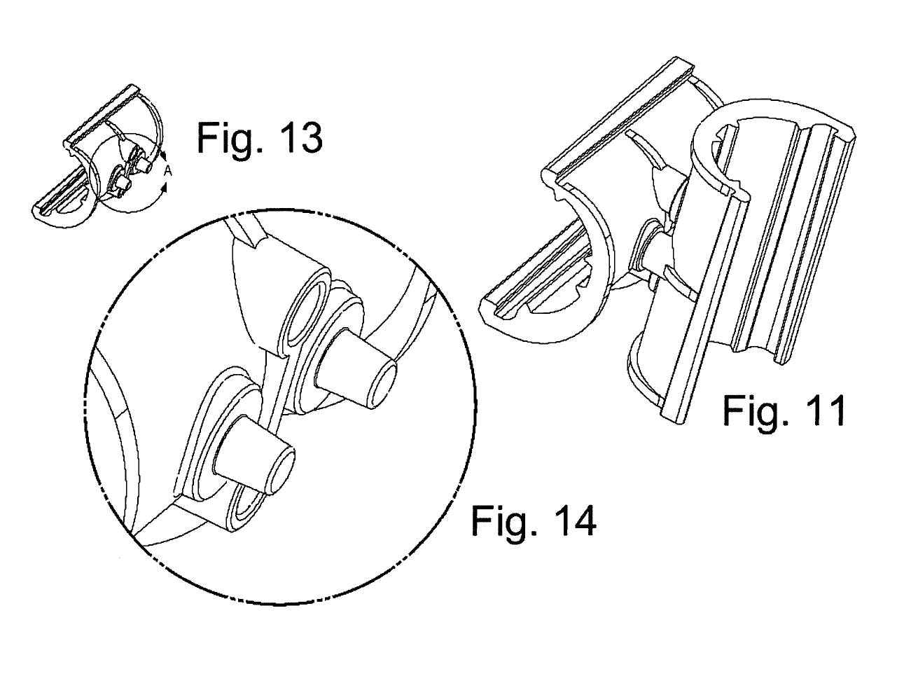

Referring to FIGS. 8-12, another preferred embodiment is illustrated and differs from the first described embodiment primarily in two ways. First, spar 80 includes a smooth inner surface and a fluted outer surface as in the first embodiment. However in this embodiment spar 80 is solid rather than formed with inner and outer walls connected by webbing. In another aspect of the second embodiment collar 82 is as described with respect to the first described embodiment, and includes flanges 84 and 86 to which sidemounts 88 are mounted. Collar 90 differs from the first described embodiment however in that collar 90 includes a pair of protruding pins 92 and a pair of holes 94. The pins are aligned on a first axis and holes 94 are aligned perpendicularly thereto. Holes 94 are sized and spaced so as to receive pins 92 from an adjacent collar, and thereby provide a collar assembly that can support to spars positioned perpendicularly to one another. In one embodiment the pins and holes are sized for an interference fit and can be dissembled for removal or reorienting the components. In another embodiment the pins and holes are glued together, and are not intended to be removed from one another once assembled.

The components described are preferably molded from a polymeric material such as ABS or polypropylene, although the invention is not limited to any particular material or method of manufacture.

While the invention has been described above by reference to the preferred embodiments, those of skill in the art will recognize that numerous changes in detail are possible without departing from the scope of the invention.

1. A modular support system comprising:
a first elongate member having an outer surface; (hollow, extruded)
a first collar adapted for interlockingly engaging the first elongate member, the collar having interlocking first and second halves;
each of the first and second collar halves having first and second flanges, the first flange of each collar half interlockingly engageable with the second flange of the other collar half to mount the first collar onto the first elongate member; and,
the first collar first collar half having a connector engageable with a first collar half of a second collar, the connector having a first position for positioning the second collar at a predetermined angle to the first collar.

2. A collar according to claim 1 further comprising the second collar half having a support member adapted for supporting a first tube at a predetermined angle to the collar. (flange, rotatable, pivoting member)

3. A collar according to claim 1 further comprising the first elongate member having an outer surface defining a plurality of longitudinal grooves; and,
at least one of the first and second collar halves having surfaces defining at least one protruding tab engaged with at least one of the plurality of longitudinal grooves.

4. A collar according to claim 2 wherein the support member adapted for supporting a first tube at a predetermined angle to the collar comprises:
the collar second half having a longitudinal flange;
a support member connected to the collar second half, the support member having at least one protruding portion adapted to receive a third elongate member, and at least one slot for receiving the longitudinal flange.

5. A collar according to claim 4 wherein the at least one slot comprises a plurality of slots, each of the plurality of slots separately engageable with the longitudinal flange to position the at least one protruding portion at a pre-selected angle relative to the second collar.

6. A collar according to claim 2 wherein the support member adapted for supporting a first tube at a predetermined angle to the collar further comprises:
at least one flange extending from the second collar half; and,
the support member rotatably mounted to the at least one flange.

7. A collar according to claim 4 wherein the support member adapted for supporting a first tube at a predetermined angle to the collar comprises:
the collar second half having a longitudinal flange;
a support member connected to the collar second half, the support member having two protruding portions adapted to receive respective third and fourth elongate members, protruding portion having at least one slot for receiving a portion of the longitudinal flange, and each protruding portion operable relative to the other.
